(19) United States
(12) Patent Application Publication
(10) Pub. No.: US 2022/0025773 A1
(43) Pub. Date: Jan. 27, 2022

(54) Transition Piece Cooling Holes for Gas Turbine Combustor

(71) Applicant: Mitsubishi Power, Ltd., Yokohama-shi (JP)

(72) Inventors: Yasuhiro WADA, Yokohama-shi (JP); Shota IGARASHI, Yokohama-shi (JP); Shohei NUMATA, Yokohama-shi (JP); Tomomi KOGANEZAWA, Yokohama-shi (JP); Hiroaki NAGAHASHI, Yokohama-shi (JP)

(21) Appl. No.: 17/378,892

(22) Filed: Jul. 19, 2021

(30) Foreign Application Priority Data
Jul. 27, 2020 (JP) 2020-126388

(51) Int. Cl. F01D 9/02; F01D 25/12

(52) U.S. Cl. CPC F01D 9/023; F01D 25/12; F05D 2260/232; F05D 2260/202; F05D 2260/201; F05D 2240/35

(57) ABSTRACT

There are provided transition piece cooling holes which make NOx reduction and combustion performance improvement possible while effectively cooling the transition piece end frame and the first-stage stator vane end wall. The transition piece cooling holes include a transition piece which guides combustion gas from a combustor to a turbine, a transition piece end frame which is installed on a turbine-side outlet of the transition piece and is disposed so as to face a first-stage stator vane end wall of the turbine with a predetermined gap being interposed, and a seal member which is fitted on the transition piece end frame and is fitted into the first-stage stator vane end wall so as to seal cooling air which is supplied into the gap. The cooling holes are made in the transition piece end frame so as to directly supply the cooling air to the first-stage stator vane end wall.

### CLAIM OF PRIORITY

The present application claims priority from Japanese Patent application serial no. 2020-126388, filed on Jul. 27, 2020, the content of which is hereby incorporated by reference into this application.

### BACKGROUND OF THE INVENTION

The present invention relates to transition piece cooling holes and particularly relates to a technology which is effectively applied to a transition piece end frame structure.

In a gas turbine for use in a general power plant and a general mechanical drive, high-pressure air which is introduced from an air compressor is introduced into a cabin through a diffuser and flows into the cabin by being divided into part to be used in a burner unit as air for combusting the combustor and part to be used for cooling the combustor and a gas turbine main body.

Combustion gas which is generated by combustion of a fuel-air mixture in the combustor is introduced into a turbine blade through a transition piece. A workload which is generated when the high-temperature and high-pressure combustion gas which is introduced into the turbine blade is adiabatically expanded is converted to axle rotational force by the turbine and thereby output is obtained from a generator.

In addition, there also exists a mechanical drive use plant which uses the gas turbine as a power source for fluid compression by rotating another compressor in place of the generator by utilizing this axle rotational force.

As a background technology in this technical field, there exists a technology which is disclosed, for example, in Japanese Unexamined Patent Application Publication No. 2013-221455. In Japanese Unexamined Patent Application Publication No. 2013-221455, “In a gas turbine high-temperature component which defines a combustion gas flow passage that combustion gas flows, the gas turbine high-temperature component in which a groove which depresses from an end face which faces another high-temperature component which is adjacent thereto along the combustion gas passage in a direction away from another high-temperature component and extends in an direction that the end face extends, a cooling passage which extends in the direction that the end face extends in a region which is sandwiched between the groove and the combustion gas passage, an introduction passage which connects the groove with the cooling passage, and an exhaust passage which connects the cooling passage with the combustion gas flow passage are formed” is disclosed.

In addition, in Japanese Unexamined Patent Application Publication No. 2007-120504, “A combustor cooling structure which includes, on a wall of a combustor transition piece, a brim which is provided on an outer periphery of the combustor transition piece which is located on a rear end which is the combustion gas discharge side and projects outward from the combustor transition piece, a transition piece seal which has a hook shape which fits on the brim, is fixed by fitting on the brim and is provided at a position where it faces an end face of the rear end of the combustor transition piece, a plurality of cooling flow grooves which are provided so as to extend in an axial direction of the combustor transition piece in the wall part of the combustor transition piece, at least some of which penetrate down to the end face of the rear end of the combustor transition piece and in which a cooling medium flows, and a through-hole which is provided in the end face of the rear end of the combustor transition piece and through which the cooling medium is discharged from the cooling flow grooves which are in the form of penetrating down to the rear end of the combustor transition piece and in which the cooling medium which is discharged through the through-hole is blown against the transition piece seal” is disclosed.

### SUMMARY OF THE INVENTION

Since the transition piece which connects the burner of the combustor with the turbine blade is exposed to the high-temperature combustion gas, it is necessary to cool the transition piece by using part of compressor discharge air. In general, structures such as a film cooling structure which protects the transition piece with an air film which is formed by injecting a fluid through a cooling hole, a convection cooling structure which cools an outer face of the transition piece with the compressor discharge air and thereby lowers the temperature of an inner metal surface of the transition piece, and so forth are adopted.

In addition, since the turbine blade is also exposed to the high-temperature combustion gas, it is necessary to lower a metal temperature by a structure of cooling the inside of the blade, the film cooling structure, and so forth.

However, in a case where cooling air is used in both the combustor and the turbine blade, such a problem arises that a local fuel-to-air ratio (a fuel-air ratio) is increased in the burner unit due to a reduction in gas turbine efficiency and a reduction in air used for combustion, the combustion gas temperature rises and also the metal temperature rises. Local combustion gas temperature rising leads to a rise of concentration of NOx (nitrogen oxides) in exhaust gas and the metal temperature rising leads to reductions in reliability and durability of high-temperature components.

In Japanese Unexamined Patent Application Publication No. 2013-221455 which is described above, although compressed air A is in contact with a corner of a stator vane shroud (an inner-side shroud 45), it does not show impingement cooling effects regarding impact angle of cooling air, and it is difficult to sufficiently cool the stator vane shroud (the inner-side shroud 45). In addition, a seal member is interposed between the transition piece end frame, and the turbine inlet and the cooling holes are made in the seal member.

In Japanese Unexamined Patent Application Publication No. 2007-120504 which is described above, for example, as illustrated in FIG. 11C, although cooling of a transition piece main body 5 and a first-stage stator vane shroud 16 is taken into consideration, in general, cooling of the transition piece end frame which is installed on the outlet part of the transition piece is not taken into consideration.

Accordingly, the present invention aims to provide transition piece cooling holes and make NOx reduction and combustion performance improvement possible while effectively cooling the transition piece end frame and the first-stage stator vane end wall.

In order to solve the abovementioned problems, according to one embodiment of the present invention, there are provided transition piece cooling holes which include a transition piece which guides combustion gas from a combustor to a turbine, a transition piece end frame which is installed on a turbine-side outlet of the transition piece and is disposed so as to face a first-stage stator vane end wall of the turbine with a predetermined gap being interposed, and a seal member which is fitted on the transition piece end frame and is fitted into the first-stage stator vane end wall so as to seal cooling air which is supplied into the gap, in which the cooling holes are arranged in the transition piece end frame so as to directly supply the cooling air to the first-stage stator vane end wall.

According to the present invention, it becomes possible to realize the transition piece cooling holes which make it possible to attain the NOx reduction and the combustion performance improvement while effectively cooling the transition piece end frame and the first-stage stator vane end wall.

Accordingly, it becomes possible to realize the high-performance transition piece cooling holes which is excellent in reliability and durability.

Subject matters, configurations and effects other than the above will become apparent from description of the following embodiments.

### BRIEF DESCRIPTION OF THE DRAWINGS

FIG. 1 is a diagram illustrating one configuration example of a general gas turbine;

FIG. 2 is a diagram illustrating one configuration example of a general combustor;

FIG. 3 is a sectional diagram illustrating one example of a transition piece end frame structure according to a first embodiment of the present invention;

FIG. 4 is an enlarged diagram illustrating one example of an area B in FIG. 3;

FIG. 5 is a sectional diagram illustrating one example of a transition piece end frame structure according to a second embodiment of the present invention are made;

FIG. 6 is a sectional diagram taken along a C-C′ line in FIG. 5;

FIG. 7 is a sectional diagram illustrating one example of a transition piece end frame structure according to a third embodiment of the present invention;

FIG. 8 is an arrow view (a perspective view) taken in a D-D′ direction in FIG. 7;

FIG. 9 is a sectional diagram illustrating one example of a transition piece end frame structure according to a fourth embodiment of the present invention;

FIG. 10 is an arrow view (a perspective view) taken in an E-E′ direction of an arrow in FIG. 9;

FIG. 11 is a sectional diagram illustrating one example of a transition piece end frame structure according to a fifth embodiment of the present invention;

FIG. 12 is an arrow view (a perspective view) taken in an F-F′ direction of an arrow in FIG. 11;

FIG. 13 is a sectional diagram illustrating one example of a transition piece end frame structure according to a sixth embodiment of the present invention;

FIG. 14 is an arrow view (a perspective view) taken in a G-G′ direction of an arrow in FIG. 13; and

FIG. 15 is a sectional diagram illustrating one example of an existing transition piece end frame structure.

### DETAILED DESCRIPTION OF THE PREFERRED EMBODIMENTS

In the following, embodiments of the present invention will be described by using the drawings. Incidentally, in the respective drawings, the same reference numerals are assigned to the same constitutional elements and detailed description of overlapped parts will be omitted.

### First Embodiment

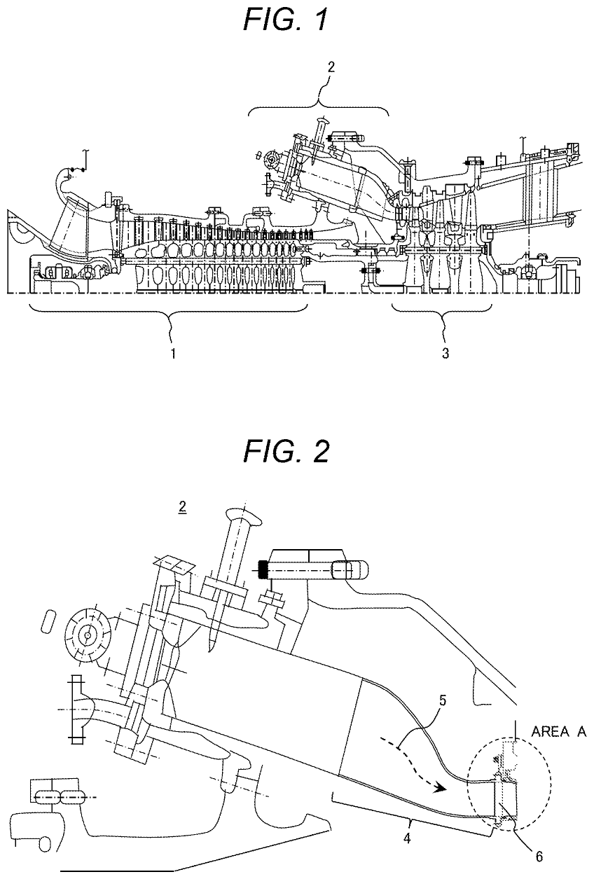

First, transition piece cooling holes which become the subject matter of the present invention and the ever-present problems will be described with reference to FIG. 1, FIG. 2, and FIG. 15. FIG. 1 is a diagram illustrating one configuration example of a general gas turbine. FIG. 2 is a diagram illustrating one configuration example of a general combustor, in which the combustor is illustrated in the form of a combustor which includes a transition piece 4 and a transition piece end frame 6. FIG. 15 is a sectional diagram illustrating one example of an existing transition piece end frame structure.

As illustrated in FIG. 1, the gas turbine is roughly configured by a compressor 1, a combustor 2, and a turbine 3. The compressor 1 adiabatically compresses air which is sucked from the atmosphere as a working fluid. The combustor 2 burns fuel by mixing compressed air which is supplied from the compressor 1 with the fuel and thereby generates high-temperature and high-pressure combustion gas. Then, in the turbine 3, when the combustion gas which is introduced from the combustor 2 expands, rotational force is generated. Air which is exhausted from the turbine 3 is released into the atmosphere.

As illustrated in FIG. 2, the transition piece 4 which guides the combustion gas from the combustor 2 to the turbine 3 is installed between the combustor 2 and the turbine 3 (in a combustion gas flowing direction 5). A flow sleeve (not illustrated) is installed around the transition piece 4. Cooling air which is discharged from the compressor 1 is taken in between the flow sleeve and the transition piece 4, the cooling air flows along a cooling air passage which is formed between the flow sleeve and the transition piece 4 and thereby the transition piece 4 is cooled with the cooling air. The transition piece end frame 6 which is a reinforcement member is installed on a turbine 3 side outlet part of the transition piece 4.

As illustrated in FIG. 15, the existing transition piece end frame 6 is disposed to face a first-stage stator vane end wall 10 (generally, called a “retainer ring”) with a predetermined gap interposed therebetween, and the transition piece end frame 6 and the first-stage end wall (the retainer ring) 10 are fitted into and fitted on a seal member 11 which seals the cooling air which is supplied into the gap respectively.

Cooling holes 26 and 28 which take in part of the cooling air which flows between the abovementioned flow sleeve and the transition piece 4 are made in the transition piece end frame 6, and the cooling air flows through the cooling holes 26 and 28 in flowing directions 27 and 29 and thereby the transition piece end frame 6 is cooled with the cooling air.

The cooling holes 26 and 28 which are made in this transition piece end frame 6 are drilled through the transition piece end frame 6 from the outer circumference side of the transition piece 4 (the transition piece end frame 6) toward a gas path face (a combustion gas flowing face) which is located on the inner circumference side of the transition piece 4 for the purpose of cooling the transition piece end frame 6.

On the other hand, the first-stage stator vane end wall 10 is cooled for promoting a reduction in metal temperature with the aid of a cooling slit (not illustrated) which is formed in the first-stage stator vane end wall 10. It is necessary to supply the cooling air also to the cooling slit and thereby a reduction in efficiency of the entire gas turbine is induced.

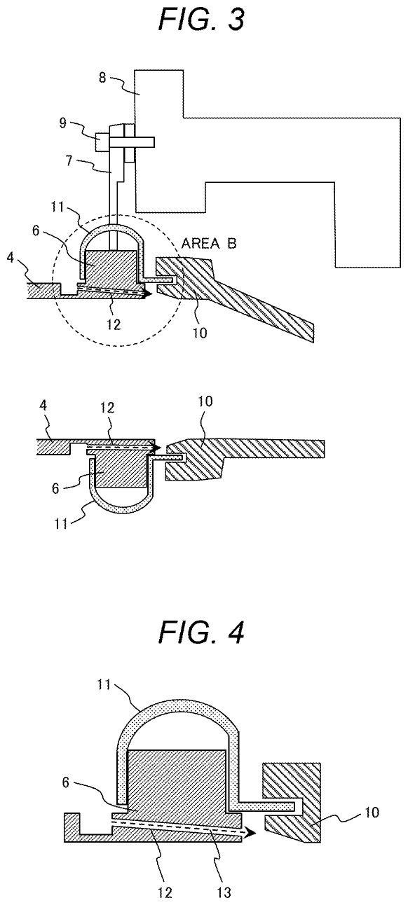

Next, a transition piece end frame structure according to the first embodiment of the present invention will be described with reference to FIG. 3 and FIG. 4. FIG. 3 is an enlarged diagram of an area A in FIG. 2 and is a sectional diagram illustrating one example of the transition piece end frame structure in the first embodiment of the present invention. FIG. 4 is an enlarged diagram of an area B in FIG. 3.

As illustrated in FIG. 3 and FIG. 4, in the first embodiment, the transition piece cooling holes include the transition piece 4 which guides the combustion gas from the combustor 2 to the turbine 3, the transition piece end frame 6 which is disposed on the turbine 3 side outlet part of the transition piece 4 and is arranged so as to face the first-stage stator vane end wall 10 of the turbine 3 with the predetermined gap interposed therebetween, and the seal member 11 which is fitted on the transition piece end frame 6 and fitted into the first-stage stator vane end wall 10 respectively thereby to seal the cooling air which is supplied into the predetermined gap.

A cooling hole 12 through which the cooling air is directly supplied to the first-stage stator vane end wall 10 is made in the transition piece end frame 6 so as to extend through the inside thereof. The cooling air flows in the cooling hole 12 in a flowing direction 13 and thereby the transition piece end frame 6 is cooled with the cooling air from the inside and also the first-stage stator vane end wall 10 is cooled with the cooling air.

In the first embodiment, the transition piece cooling holes are configured as described above, and therefore it becomes possible to reduce the amount of the cooling air which is used to cool high-temperature components while effectively cooling both the transition piece end frame 6 and the first-stage stator vane end wall 10 and to suppress local temperature rising of the combustion gas which is induced by a reduction in amount of air used for combustion. Thereby, it becomes possible to promote improvement of the reliability and the durability, the NOx reduction, and the combustion performance improvement of the gas turbine.

Incidentally, as illustrated in FIG. 4, it is desirable that the cooling hole 12 be made to have a predetermined inclination angle relative to the inner circumferential surface of the transition piece end frame 6 in order to supply the cooling air directly to an inner- circumference-side inclined part of the first-stage stator vane end wall 10. This is because the inner- circumference-side inclined part of the first-stage stator vane end wall 10 is thinned and therefore high-temperature oxidation thinning which is induced with the high-temperature combustion gas, thermal stress cracking, and so forth are liable to occur. In addition, it becomes possible to obtain not only the effect of film cooling but also the effect of impingement cooling and it becomes possible to increase cooling efficiency.

### Second Embodiment

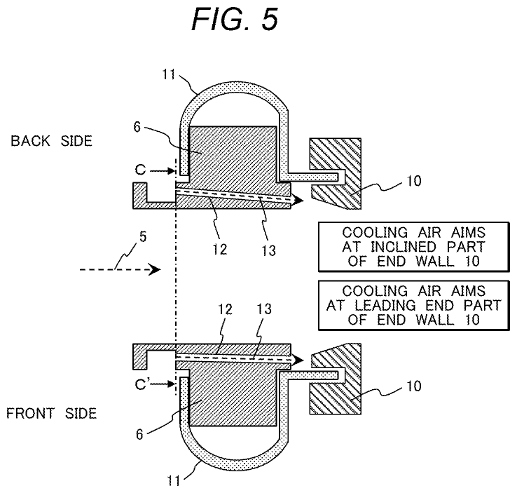

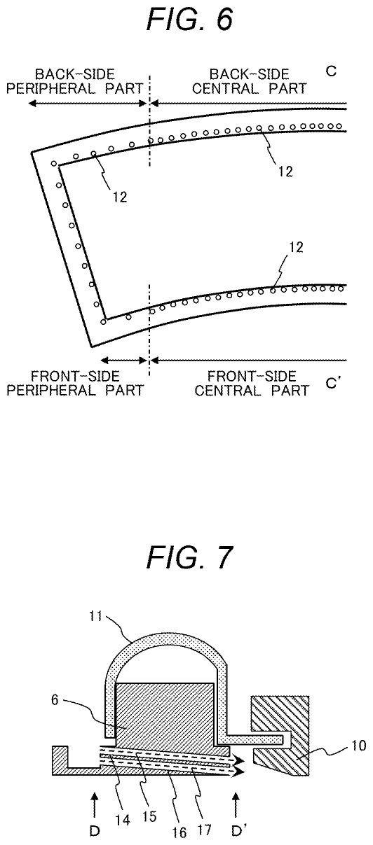

A transition piece end frame structure according to the second embodiment of the present invention will be described with reference to FIG. 5 and FIG. 6. FIG. 5 is a sectional diagram illustrating one example of the transition piece end frame structure in the second embodiment, and the upper side and the lower side of the transition piece 4 are illustrated in FIG. 5 respectively. FIG. 6 is a sectional diagram illustrating one example of an almost half area of a C-C′ section in FIG. 5.

As illustrated in FIG. 5, in the second embodiment, the transition piece cooling holes are configured such that an angle of inclination of one cooling hole 12 which is made in an inner part of the transition piece end frame 6 which is located on the upper side of the transition piece 4 relative to the inner circumferential surface of the transition piece end frame 6 is made different from an angle of inclination of another cooling hole 12 which is made in an inner part of the transition piece end frame 6 which is located on the lower side of the transition piece 4 relative to the inner circumferential surface of the transition piece end frame 6.

It becomes possible to supply the cooling air directly to respective desirable parts of the first-stage stator vane end wall 10 on the upper side and the lower side of the transition piece 4, for example, parts which reach a high temperature with ease in particular by making the angles of inclination of the cooling holes 12 which are made in the inner parts of the transition piece end frame 6 which are located on the upper side and the lower side of the transition piece 4 relative to the inner circumferential surface of the transition piece end frame 6 different from each other in this way.

In addition, the cooling hole 12 which is made in the inner part of the transition piece end frame 6 which is located on the upper side of the transition piece 4 may be configured to supply the cooling air directly to the inner-circumference-side inclined part of the first-stage stator vane end wall 10, and the cooling hole 12 which is made in the inner part of the transition piece end frame 6 which is located on the lower side of the transition piece 4 may be configured to supply the cooling air directly to an inner-circumference-side leading end of the first-stage stator vane end wall 10.

Incidentally, as illustrated in FIG. 6, it is desirable to arrange the cooling holes 12 which are made in the inner parts of the transition piece end frame 6 which are located on the upper side of the transition piece 4 such that a ratio (an arrangement pitch thereof P/a hole diameter thereof D) of the arrangement pitch to the hole diameter of the cooling holes 12 which are arranged in the vicinity of the center part of the transition piece end frame 6 becomes smaller than a ratio (an arrangement pitch thereof P/a hole diameter thereof D) of the arrangement pitch to the hole diameter of the cooling holes 12 which are arranged in the vicinity of peripheral parts of the transition piece end frame 6 in a direction which is vertical to the combustion gas flowing direction 5 in the transition piece end frame 6.

Likewise, it is also desirable to arrange the cooling holes 12 which are made in the inner parts of the transition piece end frame 6 which are located on the lower side of the transition piece 4 such that a ratio (an arrangement pitch thereof P/a hole diameter thereof D) of the arrangement pitch to the hole diameter of the cooling holes 12 which are arranged in the vicinity of the central part of the transition piece end frame 6 becomes smaller than a ratio (an arrangement pitch thereof P/a hole diameter thereof D) of the arrangement pitch to the hole diameter of the cooling holes 12 which are arranged in the vicinity of the peripheral parts of the transition piece end frame 6 in the direction which is vertical to the combustion gas flowing direction 5 in the transition piece end frame 6.

In general, since the temperature of the vicinity of the central part of the transition piece end frame 6 is higher than the temperature of the vicinity of the peripheral parts of the transition piece end frame 6, the amount of the cooling air which is supplied to the vicinity of the central part of the transition piece end frame 6 is increased by making the ratio (the arrangement pitch P/the hole diameter D) of the arrangement pitch to the hole diameter of the cooling holes 12 which are arranged in the vicinity of the central part of the transition piece end frame 6 smaller than the ratio (P/D) of the arrangement pitch P to the hole diameter D of the cooling holes 12 which are arranged in the vicinity of the peripheral parts of the transition piece end frame 6, and thereby it becomes possible to effectively cool the vicinity of the central part of the transition piece end frame 6 and the first-stage stator vane end wall 10 which faces the transition piece end frame 6.

Further, as illustrated in FIG. 6, it is more preferable to set the ratio (the arrangement pitch P/the hole diameter D) of the arrangement pitch to the hole diameter of the cooling holes 12 which are arranged in the vicinity of the central part of the transition piece end frame 6 to equal to or less than 3.1 and to set the ratio (the arrangement pitch P/the hole diameter D) of the arrangement pitch to the hole diameter of the cooling holes which are arranged in the vicinity of the peripheral parts of the transition piece end frame 6 to equal to or less than 4.0. Air which spouts out from the mutually adjacent cooling holes 12 forms a cooling film in the vicinity of the peripheral parts of the transition piece end frame 6 and thereby it becomes possible to surely cool the first-stage stator vane end wall 10 and, in addition, it becomes possible to effectively cool the vicinity of the central part of the transition piece end frame 6 by increasing the amount of the cooling air which is supplied to the vicinity of the central part of the transition piece end frame 6 by configuring in this way.

The air which spouts out from the mutually adjacent cooling holes 12 forms the cooling film continuously in the circumferential direction by setting the ratio (the arrangement pitch P/the diameter hole D) of the arrangement pitch of the cooling holes 12 to the hole diameter to equal to or less than 4.0, and consequently it becomes possible to surely cool the first-stage stator vane end wall 10.

As described above, it becomes possible to minimize a distribution amount of the cooling air by respectively setting the hole diameter D and the arrangement pitch P of the cooling holes 12 in a plurality of ranges in accordance with the amount of the cooling air which is required for the first-stage stator vane end wall 10.

Incidentally, it is not necessary to fix the ratio (the arrangement pitch P/the hole diameter D) of the arrangement pitch of the cooling holes 12 to the hole diameter thereof, and it is also possible to further reduce the amount of the cooling air by arranging the cooling holes 12 on the basis of other P/D ratios and other cooling hole diameters D in conformity to a circumferential-direction distribution of the combustion gas temperature and so forth.

### Third Embodiment

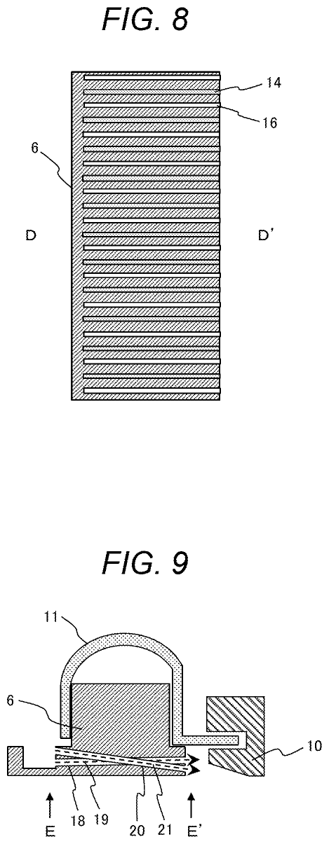

A transition piece end frame structure that according to the third embodiment of the present invention will be described with reference to FIG. 7 and FIG. 8. FIG. 7 is a sectional diagram illustrating one example of the transition piece end frame structure in the third embodiment. FIG. 8 is an arrow view (a perspective view) taken in a D-D′ direction in FIG. 7.

In the transition piece cooling holes in the third embodiment, as illustrated in FIG. 7, the cooling holes are arranged at positions which are mutually different in height measured from the inner circumference surface of the transition piece end frame 6 in a state of being divided into respective pluralities of holes as a plurality of cooling holes 14 and a plurality of cooling holes 16. There are cases where a component manufacturing tolerance and minute misalignment of assembly occur between the transition piece and the first-stage stator vane end wall. Therefore, it becomes possible to supply the cooling air to a target position through the respective cooling holes 14 and 16 even in a case where the misalignment occurs.

In addition, as illustrated in FIG. 8, the plurality of cooling holes 14 and the plurality of cooling holes 16 which are disposed at positions which are mutually different in height measured from the inner circumferential surface of the transition piece end frame 6 are alternately arranged such that the mutually adjacent cooling holes are mutually different in height in the circumferential direction of the transition piece end frame 6.

In the third embodiment, the transition piece cooling holes are configured as described above and therefore it becomes possible to evenly cool a surface of the first-stage stator vane end wall 10 which faces the transition piece end frame 6 over the entire circumference.

### Fourth Embodiment

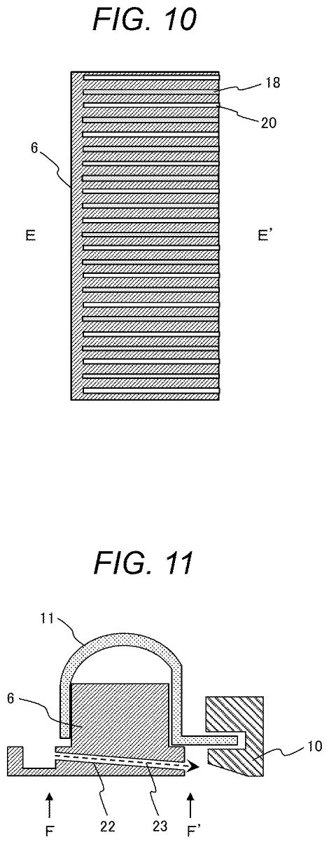

A transition piece end frame structure according to the fourth embodiment of the present invention will be described with reference to FIGS. 9 and 10. FIG. 9 is a sectional diagram illustrating one example of the transition piece end frame structure in the fourth embodiment. FIG. 10 is an arrow view (a perspective view) taken in an E-E′ direction of an arrow in FIG. 9.

In the transition piece cooling holes in the fourth embodiment, as illustrated in FIG. 9, the cooling holes are arranged in a state of being divided into a plurality of cooling holes 18 and a plurality of cooling holes 20 which are mutually different in inclination angle relative to the inner circumferential surface of the transition piece end frame 6.

In addition, as illustrated in FIG. 10, the pluralities of the cooling holes 18 and 20 which are mutually different in inclination angle relative to the inner circumferential surface of the transition piece end frame 6 are alternately arranged in the circumferential direction of the transition piece end frame 6 such that the inclination angles of the mutually adjacent cooling holes are mutually different.

The transition piece cooling holes in the fourth embodiment are configured as described above and therefore it becomes possible to evenly cool the surface of the first-stage stator vane end wall 10 which faces the transition piece end frame 6 over the entire circumference.

### Fifth Embodiment

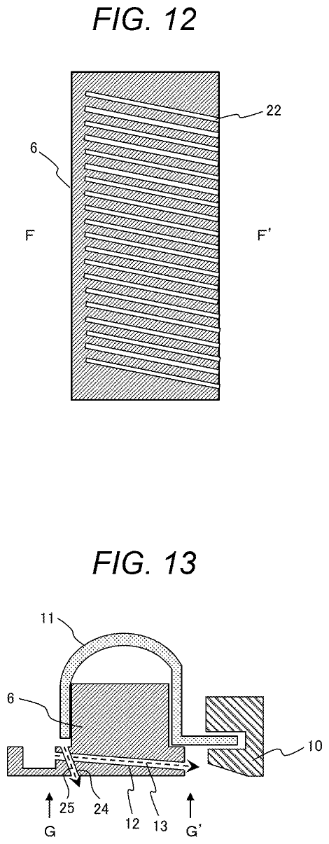

A transition piece end frame structure according to the fifth embodiment of the present invention will be described with reference to FIGS. 11 and 12. FIG. 11 is a sectional diagram illustrating one example of the transition piece end frame structure in the fifth embodiment of the present invention. FIG. 12 is an arrow view (a perspective view) taken in an F-F′ direction of an arrow in FIG. 11.

In the transition piece cooling holes in the fifth embodiment of the present invention, a plurality of cooling holes 22 are arranged at a predetermined angle (diagonally) in a mutually separated state in the circumferential direction of the transition piece end frame 6 as illustrated in FIG. 12. In a case where that the metal temperature of the transition piece end frame 6 is high becomes a problem, it becomes possible to reduce the metal temperature of the transition piece end frame 6 without increasing the amount of cooling air in comparison with a structure in which the colling holes are arranged in parallel with the axial direction of the combustor.

### Sixth Embodiment

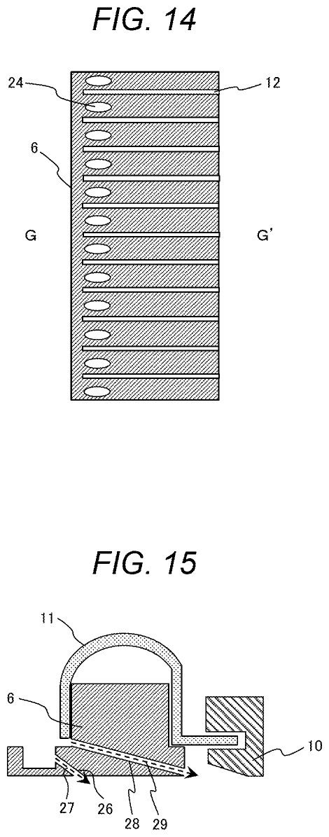

A transition piece end frame structure according to the sixth embodiment of the present invention will be described with reference to FIG. 13 and FIG. 14. FIG. 13 is a sectional diagram illustrating one example of the transition piece end frame structure in the sixth embodiment of the present invention. FIG. 14 is an arrow view (a perspective view) taken in a G-G′ direction of an arrow in FIG. 13.

In the transition piece cooling holes in the sixth embodiment, the cooling holes are configured by a first cooling hole 24 which communicates between an outer circumferential surface and an inner circumferential surface of the transition piece end frame 6 at a first angle (a predetermined angle) in the radial direction of the transition piece end frame 6 and a second cooling hole 12 which communicates between another outer circumferential surface and another inner circumferential surface of the transition piece end frame 6 at a second angle (which is different from the first angle) in the axial direction of the transition piece end frame 6.

In addition, as illustrated in FIG. 14, the first cooling holes 24 and the second cooling holes 12 are alternately arranged in the circumferential direction of the transition piece end frame 6.

Incidentally, the present invention is not limited to the abovementioned embodiments and various modified examples are included. For example, the abovementioned embodiments are described in detail for ready understanding of the present invention and are not necessarily limited to the embodiments which include all the configurations which are described above. In addition, it is possible to replace part of a configuration of one embodiment with a configuration of another embodiment, and it is also possible to add a configuration of another embodiment to a configuration of one embodiment. In addition, it is also possible to add/delete/replace another configuration to/from/with part of one configuration of each embodiment.

### REFERENCE SIGNS LIST

1 . . . compressor
2 . . . combustor
3 . . . turbine
4 . . . transition piece
5 . . . combustion gas flowing direction
6 . . . transition piece end frame
7 . . . transition piece end frame support
8 . . . housing
9 . . . fixing member
10 . . . first-stage stator vane end wall (retainer ring)
11 . . . seal member
12, 14, 16, 18, 20, 22, 24, 26, 28 . . . cooling hole
13, 15, 17, 19, 21, 23, 25, 27, 29 . . . cooling air flowing direction

What is claimed is:

1. A gas turbine combustor comprising:
a transition piece which guides combustion gas from a combustor to a turbine;
a transition piece end frame which is installed on a turbine-side outlet of the transition piece and is disposed so as to face a first-stage stator vane end wall of the turbine with a predetermined gap being interposed; and
a seal member which is fitted on the transition piece end frame and is fitted into the first-stage stator vane end wall so as to seal cooling air which is supplied into the gap,
wherein cooling holes are arranged in the transition piece end frame so as to directly supply the cooling air to the first-stage stator vane end wall.

2. The gas turbine combustor according to claim 1, wherein the cooling holes are arranged so as to supply the cooling air directly to an inner-circumference-side inclined part of the first-stage stator vane end wall.

3. The gas turbine combustor according to claim 1, wherein an inclination angle of a cooling hole which is made in an inner part of the transition piece end frame which is located on a upper side of the transition piece relative to an inner circumferential surface of the transition piece end frame is different from an inclination angle of another cooling hole which is made in an inner part of the transition piece end frame which is located on a lower side of the transition piece relative to the inner circumferential surface of the transition piece end frame.

4. The gas turbine combustor according to claim 1,
wherein a cooling hole which is made in an inner part of the transition piece end frame which is located on the upper side of the transition piece is used to supply the cooling air directly to an inner-circumference-side inclined part of the first-stage stator vane end wall, and
another cooling hole which is made in an inner part of the transition piece end frame which is located on the lower side of the transition piece is used to supply the cooling air directly to an inner-circumference-side leading end part of the first-stage stator vane end wall.

5. The gas turbine combustor according to claim 1, wherein in the cooling holes which are made in inner parts of the transition piece end frame which are located on the upper side of the transition piece, a ratio of an arrangement pitch of the cooling holes which are arranged in the vicinity of a central part of the transition piece end frame to a hole diameter thereof is smaller than a ratio of an arrangement pitch of the cooling holes which are arranged in the vicinity of peripheral parts of the transition piece end frame to a hole diameter thereof in a direction of the transition piece end frame which is vertical to a direction that the combustion gas flows.

6. The gas turbine combustor according to claim 1, wherein in the cooling holes which are made in inner parts of the transition piece end frame which are located on the lower side of the transition piece, a ratio of an arrangement pitch of the cooling holes which are arranged in the vicinity of a central part of the transition piece end frame to a hole diameter thereof is smaller than a ratio of an arrangement pitch of the cooling holes which are arranged in the vicinity of peripheral parts of the transition piece end frame to a hole diameter thereof in a direction of the transition piece end frame which is vertical to a direction that the combustion gas flows.

7. The gas turbine combustor according to claim 5, wherein the ratio of the arrangement pitch of the cooling holes which are arranged in the vicinity of the central part of the transition piece end frame to the hole diameter is equal to or less than 3.1, and the ratio of the arrangement pitch of the cooling holes which are arranged in the vicinity of the peripheral parts of the transition piece end frame to the hole diameter is equal to or less than 4.0.

8. The gas turbine combustor according to claim 1, wherein the cooling holes are arranged at positions which are mutually different in height measured from an inner circumferential surface of the transition piece end frame in a state of being divided into a plurality of cooling holes and another plurality of cooling holes in a radial direction of the transition piece end frame.

9. The gas turbine combustor according to claim 8, wherein the pluralities of cooling holes which are arranged at the positions which are mutually different in height measured from the inner circumferential surface of the transition piece end frame are mutually different in height between mutually adjacent cooling holes in a circumferential direction of the transition piece end frame.

10. The gas turbine combustor according to claim 1, wherein the cooling holes are arranged in a state of being divided into a plurality of cooling holes and another plurality of cooling holes which are mutually different in inclination angle relative to an inner circumferential surface of the transition piece end frame.

11. The gas turbine combustor according to claim 10, wherein the pluralities of cooling holes which are mutually different in inclination angle relative to the inner circumferential surface of the transition piece end frame are mutually different in inclination angle between mutually adjacent cooling holes in a circumferential direction of the transition piece end frame.

12. The gas turbine combustor according to claim 1, wherein the cooling holes are arranged at a predetermined angle (diagonally) in a mutually separated state in the circumferential direction of the transition piece end frame.

13. The gas turbine combustor according to claim 1,
wherein the cooling holes include
a first cooling hole which communicates between an outer circumferential surface and an inner circumferential surface of the transition piece end frame at a predetermined angle in the radial direction of the transition piece end frame, and
a second cooling hole which communicates between another outer circumferential surface and another inner circumferential surface of the transition piece end frame at an angle which is different from the predetermined angle in the axial direction of the transition piece end frame.

14. The gas turbine combustor according to claim 13, wherein the first cooling hole and the second cooling hole are alternately arranged in the circumferential direction of the transition piece end frame.
